(19) United States
(12) Patent Application Publication
(10) Pub. No.: US 2010/0095149 A1
(43) Pub. Date: Apr. 15, 2010

(54) DATA STORAGE METHOD AND DEVICE, AND SYSTEM THEREFOR

(75) Inventors: Yeong Kyun LEE, Hwasung-si (KR); Ki-Woong Kim, Gunpo-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 12/577,946

(22) Filed: Oct. 13, 2009

(30) Foreign Application Priority Data
Oct. 14, 2008 (KR) 2008-0100438

(51) Int. Cl. G06F 11/16; G06F 12/00; G06F 11/00

(52) U.S. Cl. 714/6; 711/112; 711/E12.001; 714/E11.062

(57) ABSTRACT

A method of storing data in a data storage device including a hard disk drive (HDD) and a non-volatile memory (NVM) includes analyzing an access command to access the NVM and transmitting data included in the access command to the HDD based on the analysis result.

### CROSS-REFERENCE TO RELATED APPLICATIONS

This application claims priority under 35 U.S.C. §119 to Korean Patent Application No. 10-2008-0100438, filed on Oct. 14, 2008, in the Korean Intellectual Property Office (KIPO), the entire contents of which are incorporated herein by reference.

### BACKGROUND

1. Field of the Invention

Exemplary embodiments relates to data storage technology, and more particularly, to a data storage method and device for receiving and analyzing an access command to access a particular memory block in a non-volatile memory and transmitting data included in the access command to a hard disk drive based on the analysis result so that the data is stored in the hard disk drive, and a system therefor.

2. Description of the Related Art

With the development of Internet network, the data processing amount has been rapidly increasing. Therefore, a data access rate transmitted through the network has increased accordingly.

Generally, a normal hard disk drive (HDD) has a disadvantage of long booting time. To solve this problem, a hybrid HDD combining a normal HDD and a non-volatile memory has been developed and used. The hybrid HDD reduces the booting time of an operating system (OS) as compared to the normal HDD. In detail, the hybrid HDD can reduce the booting time by copying files needed for booting the OS to the non-volatile memory and using the files during the booting.

While the normal HDD requires some time to rotate a spindle motor at a predetermined velocity when power is reset, a host using the hybrid HDD can reduce the booting time by reading the files necessary to boot the OS from the non-volatile memory. However, when defects occur in a part or all of the non-volatile memory, a whole data storage device may not be usable.

In addition, as a write, read or erase operation is repeated on the non-volatile memory, the ability of preserving data is lost over time, so the reliability of data decreases. Accordingly, it is desired to manage a memory block having or being likely to have a defect not to be used any more.

### SUMMARY

The present general inventive concept provides a method of safely storing data when a defect occurs in a non-volatile memory and a device and system using the method.

The present general inventive concept also provides a method of securing the reliability of data and increasing the life span of the data by replacing a defective block in a non-volatile memory with a predetermined region in a hard disk drive, and a device and system using the method.

Additional aspects and utilities of the present general inventive concept will be set forth in part in the description which follows and, in part, will be obvious from the description, or may be learned by practice of the general inventive concept.

According to some embodiments of the present general inventive concept, there is provided a data storage method including receiving an access command to access a particular memory block in a non-volatile memory, analyzing the access command, and transmitting data included in the access command to a hard disk drive (HDD) based on an analysis result.

The analyzing the access command may include receiving, by the controller, an access address included in the access command; and comparing, by the controller, the access address with an address of a memory block recorded in a defect table. The transmitting the data to the HDD may include transmitting the data to the HDD to store the data at a predetermined region corresponding to the particular memory block in the HDD based on a result of comparing the access address with the address of the memory block recorded in the defect table.

The data storage method may further include determining whether each of memory blocks included in the non-volatile memory has a defect; and replacing a defective memory block having a defect with a predetermined block of the HDD based on a result of the determination and recording information about the defective memory block and information about the predetermined block replacing the defective memory block in the defect table.

The determining whether each memory block has the defect may include counting the number of writes and/or the number of erases with respect to the each memory block; and determining that the each memory block has the defect when a count result exceeds a predetermined threshold value.

Alternatively, the determining whether each memory block has the defect may include checking an error correction code value of the memory block and determining that the memory block has the defect when a result of the checking occur error.

According to other embodiments of the present general inventive concept, there is also provided a data storage device including a non-volatile memory; a hard disk drive (HDD) including a spare block replacing a defective block of the non-volatile memory, and a controller configured to receive an access command to access a particular memory block in the non-volatile memory, analyze the access command, and performs control to transmit data included in the access command to the spare block of the HDD based on an analysis result.

The data storage device may further include a defect table to which information about the defective block and information about the spare block are recorded. The controller may compare an access address included in the access command with an address of a defective block recorded in the defect table and perform control to transmit data included in the access command to the spare block of the HDD instead of the defective block based on a result of the comparison so that the data is stored in the spare block.

The controller may determine whether each of blocks included in the non-volatile memory has a defect. The controller may count the number of writes and/or the number of erases with respect to each block of the non-volatile memory and determine whether the block has a defect based on a count result. Alternatively, the controller may check an error correction code value of each block of the non-volatile memory and determine whether the block has a defect based on a result of the check.

According to further embodiments of the present general inventive concept, there is also provided a data storage system including a main processor and a data storage device configured to receive an access command from the main processor. The data storage device includes a non-volatile memory; a hard disk drive including a spare block replacing a defective block of the non-volatile memory; and a controller configured to receive the access command, analyze the access command, and perform control to transmit data included in the access command to the spare block of the hard disk drive based on an analysis result.

The controller may compare an access address included in the access command with an address of a defective block and perform control to transmit the data to the spare block based on a result of the comparison.

According to further embodiments of the present general inventive concept, there is also provided a data storage device including a non-volatile memory, a hard disk drive, and a controller to determine that a block of the non-volatile memory is a defect block, and to transmit data of the block of the non-volatile memory to a location of the hard disk drive.

The controller may create a table to include information on the block of the non-volatile memory and a location of the hard disk drive.

The controller may receive an access command to access the block of the non-volatile memory, and control the hard disk drive to read, write, or delete the data from the location of the hard disk drive rather than controlling the non-volatile memory to read, write, or delete data from the block of the non-volatile memory.

The controller may receive an access command to access at least two blocks, which includes the defective block, of the non-volatile memory, control the hard disk drive to read, write, or delete the data from the location of the hard disk drive, and control the non-volatile memory to read, write, or delete data from other one of the at least two blocks of the non-volatile memory.

The controller may receive an access command to access the defective block of the non-volatile memory and another location of the hard disk drive, and control the hard disk drive to read, write, or delete the data from the location and the another location of the hard disk drive.

The controller may receive an access command to access at least two blocks, which includes the defective block, of the non-volatile memory, and another location of the hard disk drive, control the hard disk drive to read, write, or delete the data from the location and the another location of the hard disk drive, and control the non-volatile memory to read, write, or delete data from other one of the at least two blocks of the non-volatile memory.

The controller may determine that one of remaining blocks of the non-volatile memory is another defect block, and transmit another data of the one remaining block of the non-volatile memory to another location of the hard disk drive.

The controller may update the table to further include another information on the one remaining block of the non-volatile memory to another location of the hard disk drive.

The controller may update a table to include information on the block of the non-volatile memory and the location of the hard disk drive, in addition to information on another defective block of the non-volatile memory and another location of the hard disk drive.

According to further embodiments of the present general inventive concept, there is also provided a data storage device including a first memory, a second memory having a memory format different from the first memory, and a controller to determine that a block of the first memory is a defect block, and to transmit data of the block of the first memory to a location of the second memory.

According to further embodiments of the present general inventive concept, there is also provided a method of storing data in a data storage device, the method including providing a first memory and a second memory having a memory format different from the first memory, and determining that a block of the first memory is a defect block, and transmitting data of the block of the first memory to a location of the second memory.

According to further embodiments of the present general inventive concept, there is also provided a computer-readable medium to contain computer-readable codes as a program to perform a method of storing data in a data storage device, the method including providing a first memory and a second memory having a memory format different from the first memory, and determining that a block of the first memory is a defect block, and transmitting data of the block of the first memory to a location of the second memory.

### BRIEF DESCRIPTION OF THE DRAWINGS

The above and other features and advantages of the present general inventive concept will become more apparent by describing in detail exemplary embodiments thereof with reference to the attached drawings in which:

FIG. 1 is a block diagram illustrating a data storage system having a data storage device according to some embodiments of the present general inventive concept;

FIG. 2 is a flowchart illustrating a data storage method according to some embodiments of the present general inventive concept;

FIG. 3 is a flowchart illustrating a method of determining a defect of a memory block according to some embodiments of the present general inventive concept;

FIG. 4 is a flowchart illustrating a method of determining a defect of a memory block according to other embodiments of the present general inventive concept;

FIG. 5 is a flowchart illustrating a method of recording information on data of a block transmitted between memories and selectively accessing memories using the recorded information according to an embodiment of the present general inventive concept;

FIG. 6 is a flowchart illustrating a method of recording information on data of at least one of remaining blocks transmitted between memories and selectively accessing memories using the recorded information according to an embodiment of the present general inventive concept;

FIG. 7 is a flowchart illustrating a method of updating information on data of a block transmitted between memories according an embodiment of the present general inventive concept; and

FIG. 8 is a view illustrating a defect table according to an embodiment of the present general inventive concept.

### DETAILED DESCRIPTION OF THE EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figure. The general inventive concept may, however, be embodied in many different forms and should not be construed as limited to the embodiments set forth herein. Rather, these embodiments are provided so that this disclosure will be thorough and complete, and will fully convey the scope of the general inventive concept to those skilled in the art. In the drawings, the size and relative sizes of layers and regions may be exaggerated for clarity.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. As used herein, the term “and/or” includes any and all combinations of one or more of the associated listed items and may be abbreviated as “/”.

It will be understood that, although the terms first, second, etc. may be used herein to describe various elements, these elements should not be limited by these terms. These terms are only used to distinguish one element from another. For example, a first signal could be termed a second signal, and, similarly, a second signal could be termed a first signal without departing from the teachings of the disclosure.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and/or the present application, and will not be interpreted in an idealized or overly formal sense unless expressly so defined herein.

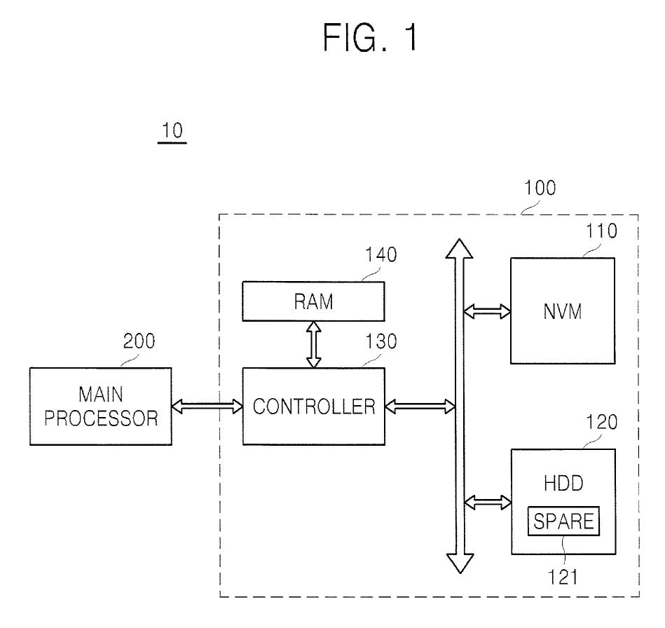

FIG. 1 is a block diagram illustrating a data storage system having a data storage device 100 according to some embodiments of the present general inventive concept. The data storage device 100 includes a first memory, such as a non-volatile memory (NVM) 110, a second memory, such as a hard disk drive (HDD) 120, a controller 130, and a third memory, such as a random access memory (RAM) 140.

Here, the first memory and the second memory may be different memories having different memory data capacities, different memory access times, different memory data process method, different memory data formats, etc.

The HDD 120 includes a spare block 121 to replace a defective block of the NVM 110. The controller 130 receives an access command to access a particular memory block of the NVM 110, performs an analyzing operation to analyze the access command, and performs a controlling operation to transmit data of the particular memory block included in the access command to the spare block 121 of the HDD 120 based on the analysis result.

Here, the “defect” indicates that write data (corresponding to read data) is different from read data or a write or read error has occurred when a write or read operation is performed at a block in the NVM 110. In addition, the defect includes a case where data cannot be stored in the block due to a physical fault or defect of the block. The “access” includes an operation with respect to the block and/or data of the block, such as a read operation, a write operation, an erase operation, and a program operation.

It is possible that the “defect” may be determined when an error would occur during a next operation with respect to data stored in the block due to a possibility (prediction) of a failure in performing the next operation on the data of the block.

The data storage device 100 including the NVM 110 and the HDD 120 may be a hybrid HDD. The NVM 110 may be any type of a memory that can retain the stored data even when not powered, for example, read only memory (ROM), programmable read only memory (PROM), erasable programmable read only memory (EPROM), electrically erasable programmable read only memory (EEPROM), flash memory, ferroelectric random access memory (FRAM), magnetic random access memory (MRAM), phase-change random access memory (PRAM), nano random access memory (NRAM), silicon-oxide-nitride-oxide-silicon (SONOS), or racetrack memory.

The NVM 110 and the HDD 120 are connected with a host through a single interface and are respectively implemented in separate memory regions inside the data storage device 100. However, the NVM 110 and the HDD 120 can operate independently or selectively as a single memory device.

Therefore, a host which is connected to the data storage device 100 can selectively control the NVM 110 and the HDD 120 to write, read, or delete data independently from each other. It is possible that the NVM 110 and the HDD 120 is exclusively controlled to write on, read from, or delete data from the NVM 110 or the HDD 120. It is also possible that the NVM 110 and the HDD 120 can be simultaneously controlled to write, read, or delete corresponding data with respect to the corresponding block.

When a defect on data and/or block occurs in the NVM 110, data may be lost, data may not be read, data may not be written, or a whole product, e.g., the data storage device 100, may not be usable. Therefore, a data storage method according to some embodiments replaces a defective block in the NVM 110 with a predetermined region in the HDD 120, thereby increasing the reliability of the data, avoiding a data/block loss, or preventing an inoperable reading/writing function with respect to the data and/or block having a defect. Accordingly, the HDD 120 may include a spare region 121 to replace a defective block occurring in the NVM 110. The spare region 121 may include at least one spare block, e.g., sector.

The HDD 120 may have a plurality of memory spaces including the spare region 121. When data is read from or written in the memory spaces in a normal operation, the spare region 121 may not be used to store the data of the normal operation. The space region 121 may be used to store data of the block having a defect of the NVM 110 in the above-described abnormal operation. The spare region 121 may be exclusively used to replace the defective block. It is possible that the data of the block having the defect can be stores in one of the memory spaces of the HDD 120 in addition to the spare region 121.

In the embodiments described herein, data reading and writing is performed in units of blocks each of which includes at least one memory cell. The data storage device 100 also includes a defect table to record information about a block having a defect in the NVM 110 and information about a spare block to replace the defective block and to store data of the block having the defect.

The defect table may be stored in the NVM 110, the HDD 120, or the controller 130. The defect table may be copied to and stored in a random access memory (RAM) 140 when the data storage device 100 is driven.

Although the RAM 140 and the controller 130 are separated in FIG. 1 for clarity of the description, the present general inventive concept is not limited thereto. The RAM 140 may be included or combined within the controller 130.

The controller 130 receives an access command from a main processor 200 (or a host) through a bus connected between the main processor 200 and the controller 130 of the HDD 120. The access command includes an access address to access at least one block to read, write, or delete data of the at least one block. When the access command is for writing or programming data to the NVM 110 or the HDD 120, the access command may further include the data. The access command received by the controller 130 is for accessing a particular memory block in the NVM 110 or in the HDD 120.

When the access command received by the controller 130 is for accessing a particular memory block in the HDD 120, the controller 130 performs control to access the particular memory block according to the access command.

When the access command is received by the controller 130 to access a particular memory block of the NVM 110, a method according to some embodiments of the present general inventive concept is used.

In detail, when an access command to access a particular memory block in the NVM 110 is output from the main processor 200, the controller 130 receives and analyzes the access command. For instance, when the access command includes an access address, the controller 130 compares the received access address with an address of a defective block recorded in the defect table.

When it is determined that the received access address is the same as the address of the defective block recorded in the defect table as a result of the comparison, the controller 130 transmits data included in the access command to the HDD 120 to store the data at a predetermined region in the HDD 120. The predetermined region may be at least a portion of the HDD 120, e.g., the spare region 121.

Consequently, the controller 130 controls the NVM 110 and the HDD 120 to store the data that is supposed to be stored at the defective memory block at the predetermined region (e.g., the spare region 121) having no defects in the HDD 120, and therefore, the reliability of the data is enhanced. The defect table may be created or updated according to the state of the memory block.

In other words, the controller 130 determines whether a defect has occurred in each of blocks included in the NVM 110 and replaces a block having a defect with a predetermined region in the HDD 120 (for example, assigns a pointer to the spare region 121), thereby preventing the loss of the data.

A reference to determine whether a defect has occurred in each of the blocks included in the NVM 110 may vary in different embodiments. For instance, the controller 130 may use the number of writes or erases in each block of the NVM 110 as the reference. The NVM 110 has a limited number of uses which may vary with a manufacturer or manufacturing environment of the NVM 110. The limited number of uses may be lifetime (life span) of, for example, the NVM 110.

In addition, the more the NVM 110 is used, the more data errors there may be during writing or reading. For instance, when the number of erases (lifetime) in the NVM 110 is limited to 1,000,000, the controller 130 may count the number of erases performed on each block in the NVM 110 and determine that a defect has occurred or will occur in the block when the count result exceeds 1,000,000. Next, the controller 130 records information about the defective block having the defect and information about a spare block to replace the defective block in the defect table. The information may include address information.

As described above, the NVM includes a number of blocks to store data therein. It is possible that the number of access of a block may be different from the number of access of other blocks due to a frequent access to read, write, delete data of a block. When any particular block is frequently accessed to read, write, delete data, the life span or accessibility of the particular block may be changed or decreased compared to other blocks.

Alternatively, the controller 130 may determine whether each block in the NVM 110 has a defect based on an error correction code (ECC) value of the block. In detail, each block in the NVM 110 stores a unique ECC value determined according to an attribute (or characteristics) of data and the ECC value can be calculated by performing a predetermined operation on data stored in the block.

Accordingly, when the attribute of the data stored in the block changes or a defect occurs in the block, the result of calculating the ECC value is abnormal. Accordingly, when the result of calculating the ECC value of each block is abnormal, the controller 130 determines that the block has a defect. Next, the controller 130 records information about the defective block having the defect and information about a spare block replacing the defective block in the defect table. The information may include address information. The controller 130 may use an error detection code (EDC) value instead of the ECC value.

The data storage system 10 includes the main processor 200 and the data storage device 100 to receive an access command output from the main processor 200. The data storage device 100 includes the NVM 110, the HDD 120 which includes the spare region 121 to replace a defective block of the NVM 110, and the controller 130 which receives and analyzes the access command and controls data included in the access command to be transmitted to the spare region 121 of the HDD 120 based on the analysis result. The HDD 120 is an example of a magnetic storage device.

The spare region 121 of the HDD 120 may have a plurality of sections to correspond to the respective blocks having the defect in the NVM 110. When the number of blocks having the defect increases, a number of sections of HDD 120 can be used to store data of the blocks having defect, and the table is updated to include the information indicating relationships between the blocks of the NVM 110 and the sections of the HDD 120.

The data storage system 10 may be any type of system including the data storage device 100. For example, the data storage system 10 may be an HDD recorder, a personal terminal such as a cellular phone, a computer such as a personal computer (PC) or a notebook, a navigator, a home automation system, an audio player such as an MP3 player, a camcorder, a video player such as a DVIX player, a storage server, or a portable multimedia player (PMP).

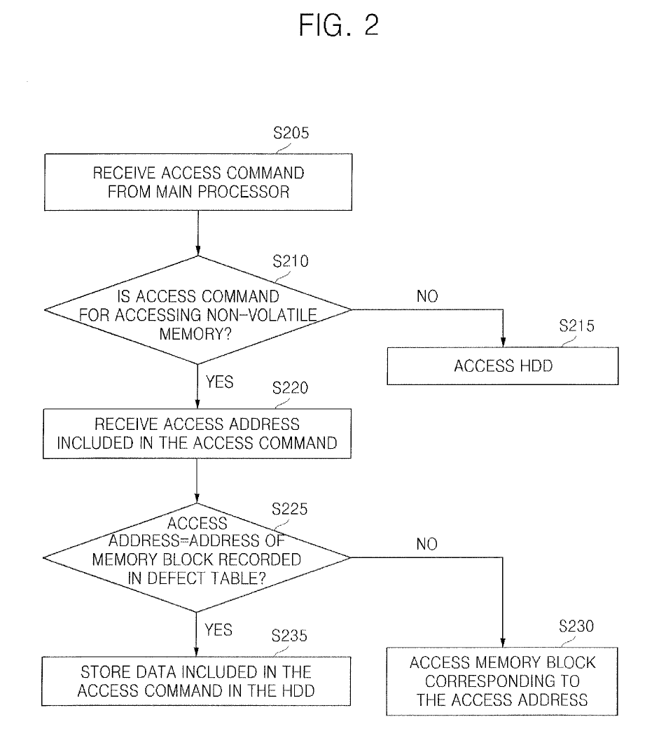

FIG. 2 is a flowchart illustrating a data storage method according to an embodiment of the present general inventive concept. Referring to FIGS. 1 and 2, the controller 130 receives an access command from the main processor 200 in operation S205. The access command may include at least one among an access address and data.

Next, the controller 130 determines whether the access command is for accessing the NVM 110 or the HDD 120 in operation S210. When it is determined that the access command is for accessing the HDD 120, the controller 130 performs control to access a block corresponding to the access address included in the access command in operation S215.

When it is determined that the access command is for accessing the NVM 110, the controller 130 receives the access address included in the access command in operation S220. Next, the controller 130 compares the received access address with addresses of memory blocks recorded in a defect table and determines whether any of the addresses in the defect table is the same as the received access address in operation S225.

When the same address as the received access address does not exist in the defect table, a memory block to be accessed by the main processor 200 does not have a defect, and therefore, the controller 130 accesses the memory block corresponding to the received access address in operation S230.

However, when the same address as the received access address exists in the defect table, the memory block has a defect, and therefore, the controller 130 controls, in a write operation, the data included in the access command to be stored at a predetermined region (e.g., the spare region 121) in the HDD 120 instead of the memory block having the defect in operation S235.

The above-described operations may be applied to a read operation. When a read command to read a particular block in the NVM 110 is received from a host, the controller 130 compares a read address corresponding to the read command with addresses of memory blocks recorded in the defect table. When the same address as the read address does not exist in the defect table, the controller 130 reads data from the particular block corresponding to the read address in the NVM 110. When the same address as the read address exists in the defect table, the controller 130, data to be read has already been stored at the predetermined region (e.g., the spare region 121) in the HDD 120 through the above-described storing operations, and therefore, the controller 130 performs control to read the data from the spare region 121.

As described above, the controller 130 may determines that a block of the NVM 110 is defective, and may control the NVM 110 to read and transmit data of the defective block of the NVM 110 to the HDD 120, and may control the HDD 120 to store the transmitted data in a corresponding section of the spare region 121.

As describe above, the controller 130 determines that a block is a defective block according to the number of access to access the block, a frequency of access to access the block with respect to a predetermined period of time, a difference between the number of access of the block and the number of access of other blocks, a comparison between the number of access and a reference number, a determination of an ECC error, etc. However, the present general inventive concept is not limited thereto. It is possible that a characteristic of usage of the block can be used as the determination of the defect. The characteristic may be a temperature, vibration, or any condition which can affect the function of the NVM 110.

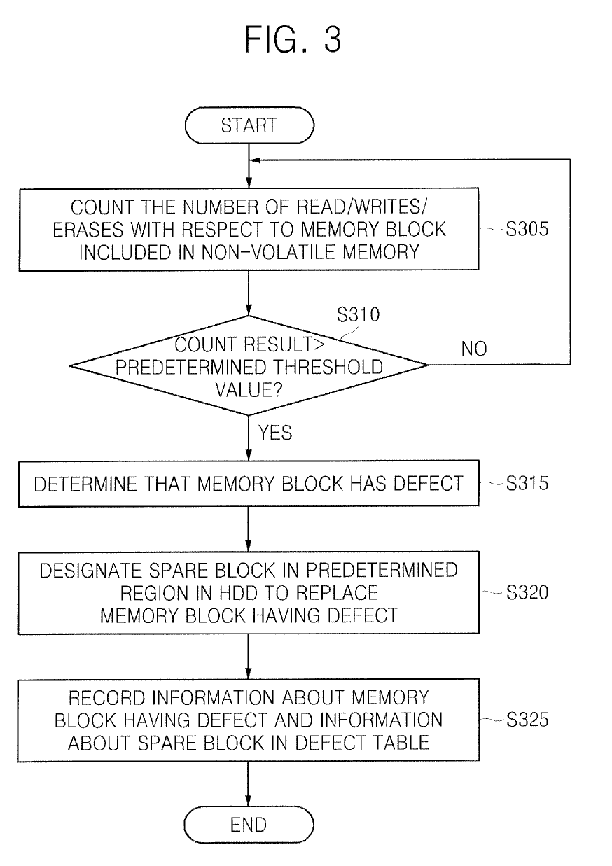

FIG. 3 is a flowchart illustrating a method of determining whether a defect has occurred in a memory block according to some embodiments. Referring to FIGS. 1 and 3, the controller 130 counts the number of writes and/or the number of erases with respect to a memory block included in the NVM 110 in operation S305. The controller 130 may perform counting periodically or each time when a write or erase operation is performed.

Next, the controller 130 determines whether the count result exceeds a predetermined threshold value in operation S310. When the count result exceeds the predetermined threshold value, the controller 130 determines that the memory block has a defect in operation S315 and designates a spare block at a predetermined region (e.g., the spare region 121) in the HDD 120 to replace the memory block having the defect in operation S320. Next, the controller 130 records information about the memory block having the defect and information about the spare block in a defect table in operation S325.

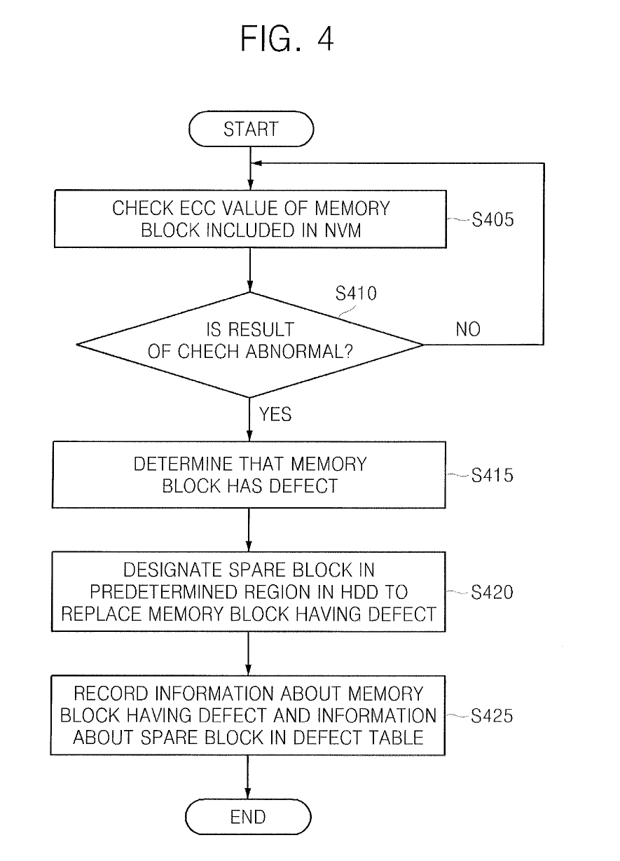

FIG. 4 is a flowchart illustrating a method of determining whether a defect has occurred in a memory block according to other embodiments. Referring to FIGS. 1 and 4, the controller 130 checks an ECC value of a memory block included in the NVM 110 in operation S405. Next, the controller 130 determines whether a result of the check is abnormal in operation S410.

When the check result is abnormal, the controller 130 determines that the memory block has a defect in operation S415 and designates a spare block at a predetermined region (e.g., the spare region 121) in the HDD 120 to replace the memory block having the defect in operation S420. Next, the controller 130 records information about the memory block having the defect and information about the spare block in a defect table in operation S425.

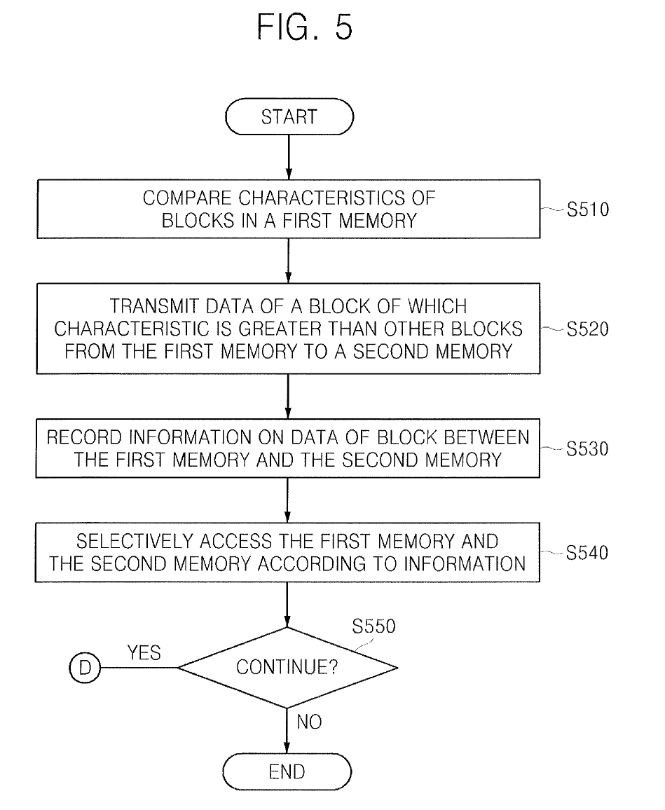

FIG. 5 is a flowchart illustrating a method of recording information on data of a block transmitted between memories and selectively accessing memories using the recorded information according to an embodiment of the present general inventive concept. Referring to FIGS. 1-5, characteristics of blocks of a first memory are compared to one another or a reference in operation S510. When a characteristic of a block is different from or greater than characteristics of other blocks, data of the block is transmitted from the first memory to a second memory in operation S520. A table is created or updated to include information on the block of the first memory and a corresponding section of the second memory in operation S530. If the block is the first block having a defect among blocks of the first memory, the table is created. If the block is the second block having a defect, the table is updated to further include information in addition to previous information of a previous block having a defect. The first memory and the second memory can be selectively accessed according to the information of the table in operation S540. When it is determined to continue the above described process, a following process D is performed in operation S550.

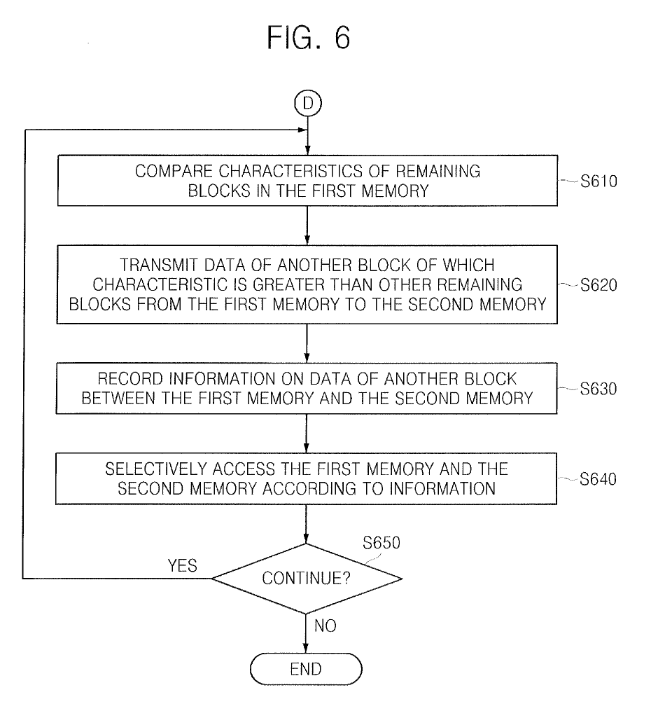

FIG. 6 is a flowchart illustrating a method of recording information on data of at least one of remaining blocks transmitted between memories and selectively accessing memories using the recorded information according to an embodiment of the present general inventive concept. Referring to FIGS. 1 through 6, characteristics of remaining blocks of the first memory are compared to one another or a reference in operation 610. When a characteristic of one of the remaining blocks is different from or greater than characteristics of other remaining blocks, data of the one remaining block is transmitted from the first memory to a second memory in operation S620. The table is updated to include information on the one remaining block of the first memory and another corresponding section of the second memory in operation S630. The first memory and the second memory can be selectively accessed according to the updated information of the table in operation S640. When it is determined to continue the above described process in operation S650, the operation S610 is performed.

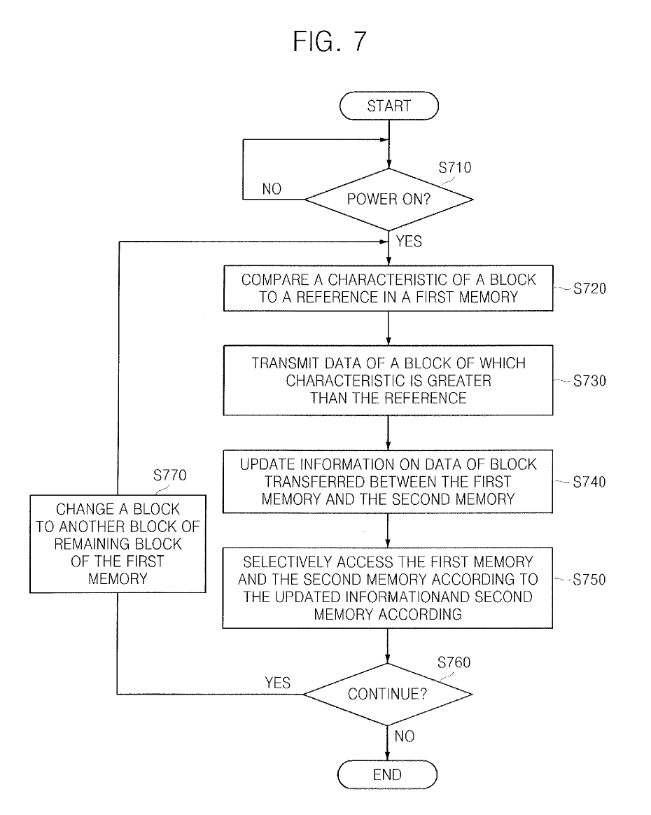

FIG. 7 is a flowchart illustrating a method of updating information on data of a block transmitted between memories according an embodiment of the present general inventive concept. It is determined whether a system (a host and/or a data storage system 10) is turned on or is in an power-on state in operation S710, a characteristic of a block is compared to a reference in operation S720. The data of the block of which characteristic is greater than the reference is transmitted from the first memory to the second memory in operation S730. The information on the data of the block transferred between the first memory and the second memory can be updated in operation S740. The first memory and the second memory can be selectively accessed according to the updated information in operation S750. When it is determined to continue the above described process in operation S760, the operation S720 is performed.

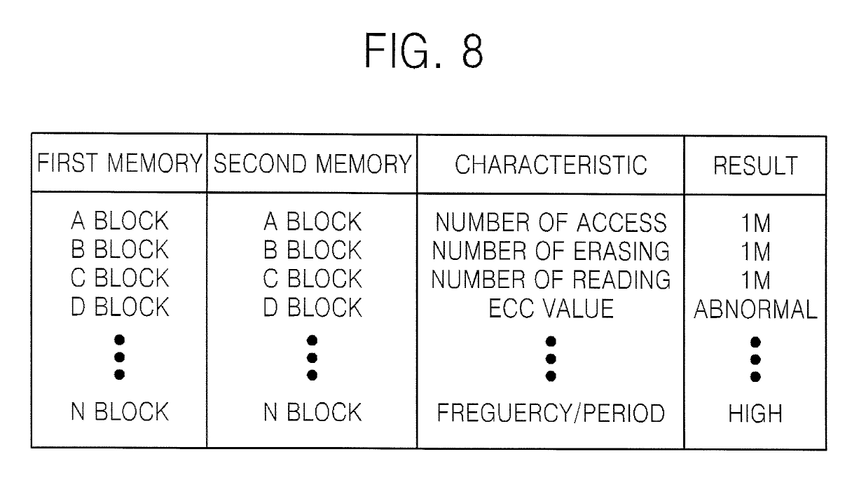

FIG. 8 is a view illustrating a defect table according to an embodiment of the present general inventive concept. The defect table may include information on one or more blocks of a first memory, information on one or more sections of a second memory to correspond to the respective blocks of the first memory, information on one or more characteristics of defects of the blocks, and/or reference as a comparison or analyzing result.

As described above, when an access command is a command to access the block of the NVM, the HDD is controlled to read, write, or delete the data from the location (section) of the HDD rather than the NVM to read, write, or delete data from the block of the non-volatile memory.

When an access command is a command to access at least two blocks, which includes the defective block, of the NVM, the HDD is controlled to read, write, or delete the data from the location (section) of the HDD, and the NVM is controlled to read, write, or delete data from other one of the at least two blocks of the NVM.

When an access command is a command to access the defective block of the NVM and another location of the HDD, and the HDD is controlled to read, write, or delete the data from the location and the another location of the hard disk drive.

When an access command is a command to access at least two blocks, which includes the defective block, of the NVM, and another location of the HDD, the HDD is controlled to read, write, or delete the data from the location and the another location of the HDD, and the NVM is controlled to read, write, or delete data from other one of the at least two blocks of the NVM.

The controller determines that one of remaining blocks of the NVM is another defect block, and transmits another data of the one remaining block of the NVM to another location (section) of the hard disk drive.

The controller may update the table to further include another information on the one remaining block of the NVM to another location of the HDD.

The controller may update a table to include information on another defective block of the NVM and new location of the HDD in addition to previous information on previous defective block of the NVM.

The present general inventive concept can also be embodied as computer-readable codes on a computer-readable medium as a program to perform a method describe above. The computer-readable medium can include a computer-readable recording medium and a computer-readable transmission medium. The computer-readable recording medium is any data storage device that can store data as a program which can be thereafter read by a computer system. Examples of the computer-readable recording medium include read-only memory (ROM), random-access memory (RAM), CD-ROMs, magnetic tapes, floppy disks, and optical data storage devices. The computer-readable recording medium can also be distributed over network coupled computer systems so that the computer-readable code is stored and executed in a distributed fashion. The computer-readable transmission medium can transmit carrier waves or signals (e.g., wired or wireless data transmission through the Internet). Also, functional programs, codes, and code segments to accomplish the present general inventive concept can be easily construed by programmers skilled in the art to which the present general inventive concept pertains.

According to some embodiments, data loss occurring due to a defect in an NVM can be prevented. In addition, since a defective block in the NVM is replaced using an HDD, the reliability of data stored in a storage device can be increased.

Although a few embodiments of the present general inventive concept have been illustrated and described, it will be appreciated by those skilled in the art that changes may be made in these embodiments without departing from the principles and spirit of the general inventive concept, the scope of which is defined in the appended claims and their equivalents.

1-6. (canceled)

7. A data storage device comprising:
a non-volatile memory;
a hard disk drive (HDD) comprising a spare block to replace a defective block of the non-volatile memory; and
a controller configured to receive an access command to access a particular memory block in the non-volatile memory, to analyze the access command, and to transmit data included in the access command to the spare block of the HDD based on an analysis result.

8. The data storage device of claim 7, further comprising:
a defect table to which information about the defective block and information about the spare block are recorded.

9. The data storage device of claim 8, wherein the controller compares an access address included in the access command with an address of a defective block recorded in the defect table and performs control to transmit data included in the access command to the spare block of the HDD instead of the defective block based on a result of the comparison so that the data is stored in the spare block.

10. The data storage device of claim 7, wherein the controller determines whether each of blocks included in the non-volatile memory has a defect.

11. The data storage device of claim 10, wherein the controller counts the number of writes and/or the number of erases with respect to each block of the non-volatile memory and determines whether the block has a defect based on a count result.

12. The data storage device of claim 10, wherein the controller check an error correction code value of each block of the non-volatile memory and determines whether the block has a defect based on a result of the check.

13. A data storage system comprising:
a main processor; and
a data storage device configured to receive an access command from the main processor, wherein the data storage device including:
a non-volatile memory;
a hard disk drive (HDD) comprising a spare block replacing a defective block of the non-volatile memory; and
a controller configured to receive the access command, analyze the access command, and perform control to transmit data included in the access command to the spare block of the HDD based on an analysis result.

14. The data storage system of claim 13, wherein the controller compares an access address included in the access command with an address of a defective block and performs control to transmit the data to the spare block based on a result of the comparison.

15. A data storage device comprising:
a non-volatile memory;
a hard disk drive; and
a controller to determine that a block of the non-volatile memory is a defect block, and to transmit data of the block of the non-volatile memory to a location of the hard disk drive.

16. The data storage device of claim 15, wherein the controller creates a table to include information on the block of the non-volatile memory and a location of the hard disk drive.

17. The data storage device of claim 16, wherein the controller receives an access command to access the block of the non-volatile memory, and controls the hard disk drive to read, write, or delete the data from the location of the hard disk drive rather than controlling the non-volatile memory to read, write, or delete data from the block of the non-volatile memory.

18. The data storage device of claim 16, wherein the controller receives an access command to access at least two blocks, which includes the defective block, of the non-volatile memory, controls the hard disk drive to read, write, or delete the data from the location of the hard disk drive, and controls the non-volatile memory to read, write, or delete data from other one of the at least two blocks of the non-volatile memory.

19. The data storage device of claim 16, wherein the controller receives an access command to access the defective block of the non-volatile memory and another location of the hard disk drive, and controls the hard disk drive to read, write, or delete the data from the location and the another location of the hard disk drive.

20. The data storage device of claim 16, wherein the controller receives an access command to access at least two blocks, which includes the defective block, of the non-volatile memory, and another location of the hard disk drive, controls the hard disk drive to read, write, or delete the data from the location and the another location of the hard disk drive, and controls the non-volatile memory to read, write, or delete data from other one of the at least two blocks of the non-volatile memory.

21. The data storage device of claim 16, wherein the controller determines that one of remaining blocks of the non-volatile memory is another defect block, and to transmit another data of the one remaining block of the non-volatile memory to another location of the hard disk drive.

22. The data storage device of claim 21, wherein the controller updates the table to further include another information on the one remaining block of the non-volatile memory to another location of the hard disk drive.

23. The data storage device of claim 15, wherein the controller updates a table to include information on the block of the non-volatile memory and the location of the hard disk drive, in addition to information on another defective block of the non-volatile memory and another location of the hard disk drive.

24-26. (canceled)
